(19) United States
(12) Patent Application Publication
(10) Pub. No.: US 2013/0223700 A1
(43) Pub. Date: Aug. 29, 2013

(54) ELECTRONIC DEVICE AND METHOD FOR PROTECTING PERSONAL DATA VIA FINGERPRINT RECOGNITION

(71) Applicants: REN-WEN HUANG, Shenzhen City (CN); QIANG YOU, Shenzhen City (CN); JUN-WEI ZHANG, Shenzhen City (CN); JUN ZHANG, Shenzhen City (CN); TSUNG-JEN CHUANG, Tu-Cheng (TW); SHIH-FANG WONG, Tu-Cheng (TW)

(72) Inventors: REN-WEN HUANG, Shenzhen City (CN); QIANG YOU, Shenzhen City (CN); JUN-WEI ZHANG, Shenzhen City (CN); JUN ZHANG, Shenzhen City (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/452,559

(22) Filed: Apr. 20, 2012

(30) Foreign Application Priority Data
Feb. 28, 2012 (CN) 201210047509.2

(51) Int. Cl. G06K 9/62

(52) U.S. Cl. 382/124

(57) ABSTRACT

A method protects personal data of an electronic device. Different capacitance values between a plurality of points of a fingertip and an electrode layer of a capacitive touch screen of the electronic device are detectable when the capacitive touch screen is touched by the fingertip, and a representation of a fingerprint is acquired according to distribution of the detected capacitance values. If the acquired fingerprint does not match with any predetermined fingerprint, predetermined personal data of the electronic device is protected. If the acquired fingerprint matches with at least one of the predetermined fingerprints, the protection of the personal data is released.

### BACKGROUND

1. Technical Field

Embodiments of the present disclosure relate generally to data security technologies, and particularly to an electronic device and method for protecting personal data via fingerprint recognition.

2. Description of Related Art

Electronic devices, such as mobile phones and personal digital assistants (PDA), may be used to store personal data. Users may experience difficulties if their personal data is accessed by unauthorized individuals. Therefore, security of the personal data is desired. Many electronic devices may apply fingerprint recognition technologies to increase security of the personal data. However, extra devices, such as fingerprint scanners, are utilized for recognizing fingerprints, which is costly and inconvenient.

### BRIEF DESCRIPTION OF THE DRAWINGS

FIG. 1 is a schematic block diagram of an exemplary embodiment of an electronic device including a data protection system.

FIG. 2 is a schematic diagram illustrating one example of a touch screen of the electronic device of FIG. 1.

FIG. 3 is a flowchart of one embodiment of a method for protecting personal data implemented by the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

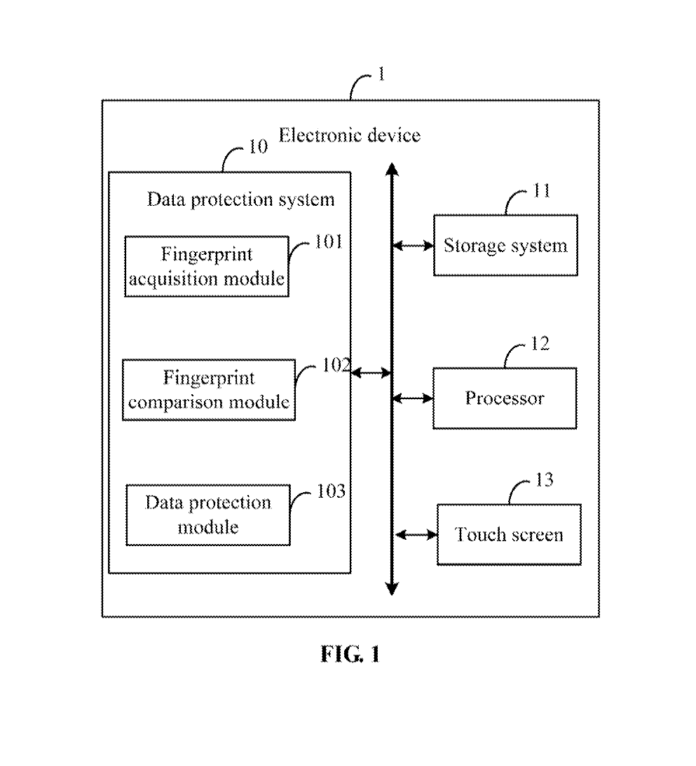

FIG. 1 is a schematic diagram of an electronic device 1 in accordance with an exemplary embodiment. The electronic device 1 includes a data protection system 10, a storage system 11, at least one processor 12, and a touch screen 13. In one embodiment, the electronic device 1 may be, for example, a mobile phone or a personal digital assistant (PDA). The touch screen 13 is a capacitive touch screen. FIG. 1 is only one example of the electronic device 1, and the electronic device 1 can include more or fewer components than those shown in the embodiment, or have a different configuration of the components.

The data protection system 10 includes a fingerprint acquisition module 101, a fingerprint comparison module 102, and a data protection module 103. The modules 101-103 may include computerized codes in the form of one or more programs that are stored in the storage system 11. The computerized codes include computer-readable program codes (instructions) that are executed by at least one processor 12 to provide function for the modules 101-103. The storage system 11 may be a cache or a dedicated memory, such as an erasable programmable read only memory (EPROM), a hard disk drive (HDD), or a flash memory. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The fingerprint acquisition module 101 acquires an electronic representation of a fingerprint (fingerprint) through the touch screen 13 when the touch screen 13 is touched by a fingertip. Details of acquiring the fingerprint are provided as follows.

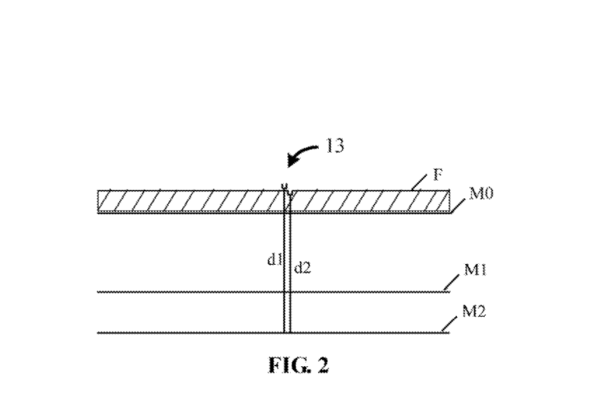

FIG. 2 is a schematic diagram illustrating one example of the touch screen 13 of the electronic device 1 of FIG. 1. The touch screen 13 includes surface M0, a glass layer M1, and an electrode layer M2. The glass layer M1 is disposed on/above the electrode layer M2. The surface M0 is disposed on/above the glass layer M1. When the fingertip touches the surface M0 of the touch screen 13, the fingertip functions as another electrode layer opposite to the electrode layer M2, effectively one or more capacitors between a plurality of points of the fingertip touching the touch screen 13 and the electrode layer M2 are thus defined. Therefore, a plurality of capacitances can be detected by the touch screen 13. The values of the detected capacitances (hereinafter “capacitance values”) are inversely proportion to a distance between the fingertip and the electrode layer M2. It is known that a fingerprint includes both concave and convex textures, and the distance between the convex textures and the electrode layer M2 is inherently less than the distance between the concave textures and the electrode layer M2 when the fingertip touches the surface M0 of the touch screen 13. Therefore, the detected capacitances corresponding to the convex textures of the fingertip are different to the capacitances corresponding to the concave textures of the fingertip. The fingerprint acquisition module 101 may acquire the fingerprint according to the distribution of the detected capacitance values. For example, the fingerprint acquisition module 101 may draw the convex textures according to the points of the fingertip corresponding to the capacitance values that are greater than a predetermined value, and draw the concave textures according to the points of the fingertip corresponding to the capacitance values that are less than or equal to the predetermined value. Then, the fingerprint acquisition module 101 correlates and synthesizes the convex textures and the concave textures to acquire recognition of the fingerprint.

In addition, if the fingertip touches the surface M0 with heavy pressure, the concave textures may be nearer to the surface M0 as well as the convex textures, and the distance between the convex textures and the electrode layer M2 may be equal to or close to the distance between the concave textures and the electrode layer M2. Thus, the concave textures and the convex textures may not be capable of being distinguished according to the detected capacitance values. In order to avoid the problem mentioned above, an elastic film (e.g., “F” in FIG. 2) covers the surface M0 of the touch screen 13. Even though the fingertip is applied heavily on the touch screen 13, the convex textures may extend into the surface of the elastic film F towards the surface M0 of the touch screen 13 while the concave textures remain at or above the surface of the elastic film F. The use of the elastic film F enables the distance between the convex textures and the electrode layer M2 (e.g., “d2” in FIG. 2) to remain inherently less than the distance between the concave textures and the electrode layer M2 (e.g., “d1” in FIG. 2), so that the fingerprint can be nevertheless clarified according to the detected capacitance values.

The fingerprint comparison module 102 compares the acquired fingerprint with one or more predetermined fingerprints stored in the storage system 11, and determines whether the acquired fingerprint matches with at least one of the predetermined fingerprints. The predetermined fingerprints maybe preset by an owner of the electronic device 1, and the predetermined fingerprints may belong to the owner or any other individuals that are authorized by the owner. In one embodiment, the fingerprint comparison module 102 may calculate a similarity between the acquired fingerprint and each of the predetermined fingerprints using any known algorithm for calculating similarity between images, and determines whether the acquired fingerprint matches on a percentage basis with at least one of the predetermined fingerprints according to the calculated similarity. For example, if a calculated similarity is greater than a predetermined value, such as 80%, the acquired fingerprint is determined to be a match for one of the predetermined fingerprints. If each calculated similarity is not greater than the predetermined value, the acquired fingerprint is determined to be unmatched with any of the predetermined fingerprints.

The data protection module 103 protects predetermined personal data (e.g., private videos, images, important documents, and other similar information) stored in the storage system 11, by means of hiding or encrypting the personal data, if the acquired fingerprint does not match with any of the predetermined fingerprints. If the acquired fingerprint matches with at least one of the predetermined fingerprints, the data protection module 103 releases the protection of the personal data, such as by mean of unhiding or decrypting the predetermined data. In the embodiment, any data needing to be protected can be set as the personal data. The personal data is marked or initialized to be protected every time when the electronic device 1 is started or restarted, and the protection of the personal data is not released until an acquired fingerprint is determined to match with any of the predetermined fingerprints.

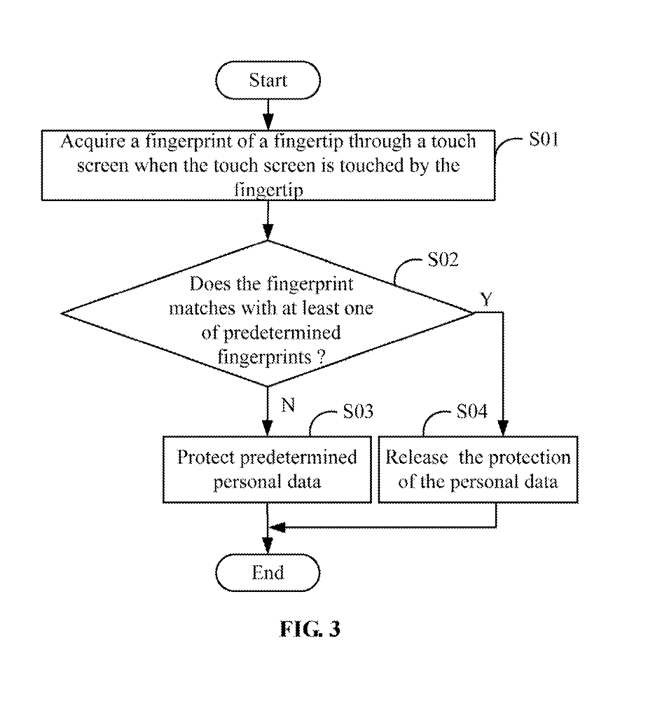

FIG. 3 is a flowchart of one embodiment of a method for protecting personal data implemented by the electronic device 1 of FIG. 1. Depending on the embodiment, additional steps may be added, others removed, and the ordering of the steps may be changed.

In step S01, the fingerprint acquisition module 101 acquires a representation of a fingerprint through the touch screen 13. Details of acquisition of the fingerprint are as described above.

In step S02, the fingerprint comparison module 102 compares the acquired fingerprint with one or more predetermined fingerprints stored in the storage system 11, and determines whether the acquired fingerprint matches with at least one of the predetermined fingerprints. If the acquired fingerprint does not match with any of the predetermined fingerprints, step S03 is implemented. If the acquired fingerprint matches with at least one of the predetermined fingerprints, step S04 is implemented. In one embodiment, the fingerprint comparison module 102 may calculate a similarity between the acquired fingerprint and each of the predetermined fingerprints using any known similarity calculation algorithm, and determines whether the acquired fingerprint matches with at least one of the predetermined fingerprints on a percentage basis according to the calculated similarity.

In step S03, the data protection module 103 protects predetermined personal data stored in the storage system 11, such as by hiding or encrypting the data.

In step S04, the data protection module 103 releases the protection of the personal data by unhiding or decrypting the predetermined data. In the embodiment, any data needing to be protected can be set as the personal data. The personal data can be marked and initialized to be protected when the electronic device 1 is started or restarted, and the protection of the personal data remains in place until any acquired fingerprint matches with any of the predetermined fingerprints.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for protecting personal data of an electronic device, the electronic device comprising a capacitive touch screen and a storage system for storing a plurality of predetermined fingerprints and predetermined personal data, the method comprising:
detecting different capacitance values between an electrode layer of the capacitive touch screen and a plurality of points of a fingertip touching the capacitive touch screen;
acquiring a fingerprint of the fingertip according to distribution of the detected capacitance values;
comparing the acquired fingerprint with each of the predetermined fingerprints, and determining whether the acquired fingerprint matches with at least one of the predetermined fingerprints; and
protecting the predetermined personal data if the acquired fingerprint does not match with any of the predetermined fingerprints, or releasing the protection of the personal data if the acquired fingerprint matches with at least one of the predetermined fingerprints.

2. The method according to claim 1, wherein the acquired fingerprint is determined to be a match according to a similarity between the fingerprint and each of the predetermined fingerprints calculated by a similarity calculation algorithm.

3. The method according to claim 1, wherein the fingerprint is acquired by:
drawing convex textures of the fingertip according to the points of the fingertip corresponding to the detected capacitance values greater than a predetermined value;
drawing concave textures of the fingertip according to the points of the fingertip corresponding to the detected capacitance values not greater than the predetermined value; and
correlating and synthesizing the convex textures and the concave textures to acquire a recognition of the fingerprint.

4. The method according to claim 1, wherein the capacitive touch screen comprises an elastic film covering a surface of the capacitive touch screen, the elastic film being deformed when the elastic film is touched by the fingertip.

5. The method according to claim 1, wherein the personal data is protected by hiding or encrypting the personal data and the protection of the personal data is released by unhiding or decrypting the personal data.

6. The method according to claim 1, wherein the personal data is marked or initialized to be protected every time when the electronic device is started or restarted, and the protection of the personal data is not released until an acquired fingerprint is determined to match with any of the predetermined fingerprints.

7. An electronic device, comprising:
a capacitive touch screen;
a storage system that stores a plurality of predetermined fingerprints and predetermined personal data;
at least one processor; and
one or more programs stored in the storage system and executed by the at least one processor, the one or more programs comprising:
a fingerprint acquisition module that detects different capacitance values between an electrode layer of the capacitive touch screen and a plurality of points of a fingertip touching a surface of the capacitive touch screen, and acquires a fingerprint according to distribution of the detected capacitance values;
a fingerprint comparison module that compares the acquired fingerprint with each of the predetermined fingerprints, and determines whether the acquired fingerprint matches with at least one of the predetermined fingerprints; and
a data protection module that protects the predetermined personal data if the acquired fingerprint does not match with any of the predetermined fingerprints, or releases the protection of the personal data if the acquired fingerprint matches with at least one of the predetermined fingerprints.

8. The electronic device according to claim 7, wherein the fingerprint comparison module determines whether the acquired fingerprint matches with at least one of the predetermined fingerprints according to a similarity between the fingerprint and each of the predetermined fingerprints calculated by a similarity calculation algorithm.

9. The electronic device according to claim 7, wherein the fingerprint is acquired by:
drawing convex textures of the fingertip according to the points of the fingertip corresponding to the detected capacitance values greater than a predetermined value;
drawing concave textures of the fingertip according to the points of the fingertip corresponding to the detected capacitance values not greater than the predetermined value; and
correlating and synthesizing the convex textures and the concave textures to acquire a recognition of the fingerprint.

10. The electronic device according to claim 7, wherein the capacitive touch screen comprises an elastic film covering the surface of the capacitive touch screen, the elastic film being deformed when the elastic film is touched by the fingertip.

11. The electronic device according to claim 7, wherein the personal data is protected by hiding or encrypting the personal data and the protection of the personal data is released by unhiding or decrypting the personal data.

12. The electronic device according to claim 7, wherein the personal data is marked or initialized to be protected every time when the electronic device is started or restarted, and the protection of the personal data is not released until an acquired fingerprint is determined to match with any of the predetermined fingerprints.
